(19) United States
(12) Patent Application Publication
(10) Pub. No.: US 2012/0198195 A1
(43) Pub. Date: Aug. 2, 2012

(54) DATA STORAGE SYSTEM AND METHOD

(75) Inventor: John Johnson Wylie, San Francisco, CA (US)

(73) Assignee: Hewlett-Packard Development Company, L.P., Houston, TX (US)

(21) Appl. No.: 13/019,877

(22) Filed: Feb. 2, 2011

(51) Int. Cl. G06F 12/00

(52) U.S. Cl. 711/170; 711/E12.001

(57) ABSTRACT

A data storage system including a storage device. The storage device may include a plurality of data storage drives that may be logically divided into a plurality of groups and arranged in a plurality of rows and a plurality of columns such that each column contains only data storage drives from distinct groups. Furthermore, the storage device may include a plurality of parity storage drives that correspond to the rows and columns of data storage drives.

### BACKGROUND

This section is intended to introduce the reader to various aspects of art, which may be related to various aspects of the present invention that are described or claimed below. This discussion is believed to be helpful in providing the reader with background information to facilitate a better understanding of the various aspects of the present invention. Accordingly, it should be understood that these statements are to be read in this light, and not as admissions of prior art.

Storage systems are relied upon to handle and store data and, thus, typically implement some type of scheme for recovering data that has been lost, degraded, or otherwise compromised. At the most basic level, one recovery scheme may involve creating one or more complete copies or mirrors of the data being transferred or stored. Although such a recovery scheme may be relatively fault tolerant, it is not very efficient with respect to the amount of duplicate storage space utilized. Other recovery schemes may involve performing a parity check. Thus, for instance, in a storage system having stored data distributed across multiple disks, one disk may be used solely for storing parity bits. While this type of recovery scheme requires less storage space than a mirroring scheme, it may not be as fault tolerant as the mirroring scheme, since any two device failures result in an inability to recover compromised data.

Various recovery schemes for use in conjunction with storage systems have been developed with the goal of increasing efficiency (in terms of the amount of extra data generated) and fault tolerance (i.e., the extent to which the scheme can recover compromised data). These recovery schemes generally involve the creation of erasure codes that are adapted to generate redundancies for the original data packets, thereby encoding the data packets in a prescribed manner. If such data packets become compromised, for example, from a disk or sector failure, such redundancies could enable recovery of the compromised data, or at least portions thereof. Various types of erasure codes are known, such as Reed-Solomon codes, RAID variants, or array codes (e.g., EVENODD, RDP, etc.) However, encoding or decoding operations of such erasure codes often are computationally demanding, which, though often useful in communication network systems, render their implementation cumbersome in storage systems.

### BRIEF DESCRIPTION OF THE DRAWINGS

FIG. 1. is a block diagram of a storage system in accordance with an embodiment;

FIG. 2 is a block diagram of a controller and a storage device of FIG. 1 in accordance with an embodiment;

FIG. 3 is a flow diagram of a technique to construct an erasure code for use with the storage system of FIG. 1 in accordance with an embodiment; and

FIG. 4 is another block diagram of a controller and a storage device of FIG. 1 in accordance with an embodiment.

### DETAILED DESCRIPTION OF SPECIFIC EMBODIMENTS

One or more exemplary embodiments of the present disclosure will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

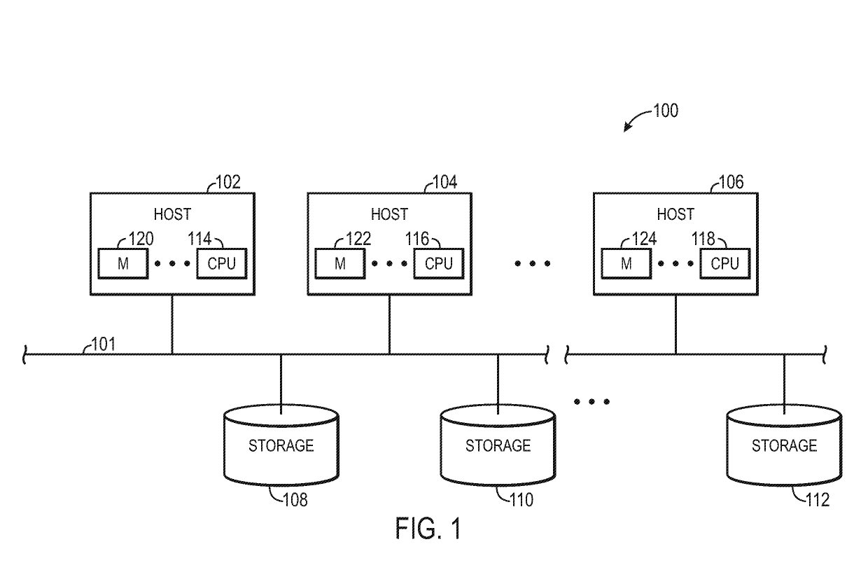

FIG. 1 illustrates an exemplary arrangement of a storage system 100, which includes a plurality of computer hosts 102, 104, 106 (which may cumulatively be referred to as 102-106), and a plurality of storage devices 108, 110, 112 (which may cumulatively be referred to as 108-112). In one embodiment, the hosts 102-106 and storage devices 108-112 may be interconnected by a network 101. The network 101 may include, for example, a local area network (LAN), a wide area network (WAN), a storage area network (SAN), the Internet, or any other type of communication link or combination of links. In addition, the network 101 may include system busses or other fast interconnects. The system 100 shown in FIG. 1 may be any one of an application server farm, a storage server farm (or storage area network), a web server farm, a switch or router farm, etc. Although three hosts 102-106 and three storage devices 108-112 are depicted in FIG. 1, it is understood that the system 100 may include more or less than three hosts and three storage devices, depending on the particular application in which the system 100 is employed. The hosts may be, for example, computers (e.g., application servers, storage servers, web servers, etc.), communication modules (e.g., switches, routers, etc.) and other types of machines. Although each of the hosts is depicted in FIG. 1 as being contained within a box, a particular host may be a distributed machine, which has multiple nodes that provide a distributed and parallel processing system. Further, each of the hosts 102-106 may include one or multiple processors (e.g., CPUs) 114, 116, 118 (which may cumulatively be referred to as CPUs 114-118), and one or multiple memories 120, 122, 124 (which may cumulatively be referred to as 120-124) for storing various applications and data, for instance. As used here, a “processor” can refer to a single component or to plural components (e.g., one CPU or multiple CPUs). A processor can also include a microprocessor, microcontroller, processor module or subsystem, programmable integrated circuit, programmable gate array, or another control or computing device.

Furthermore, data and instructions may be stored in respective storage devices (e.g., memories 120-124), which may be implemented as one or more computer-readable or machine-readable storage media. For instance, in addition to instructions of software, CPUs 114-118 can access data stored in memories 120-124 to perform encoding, decoding, or other operations. For instance, recovery equations corresponding to encoded data objects stored across the storage devices 108-112 may be maintained in lookup tables in memories 120-124. The storage media may include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed herein, can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components.

The storage devices 108-112 are adapted to store data associated with the hosts 102-106. Each of the hosts 102-106 could be coupled to one or more storage devices 108-112, and each of the hosts 102-106 could access the storage devices 108-112 for storing and/or retrieving data from those devices. Each of the storage devices 108-112 could be an independent memory bank. Alternatively, the storage devices 108-112 could be interconnected, thus forming a large memory bank or a subcomplex of a large memory bank. The storage devices 108-112 may be, for example, storage disks, magnetic memory devices, optical memory devices, flash memory devices, combinations thereof, etc., depending on the particular implementation of the system 100 in which the devices are employed. In some embodiments, each storage device 108-112 may include multiple storage disks, magnetic memory devices, optical memory devices, flash memory devices, etc. In this manner, each storage device 108-112 may be an array of disks such as a redundant array of independent disks (RAID).

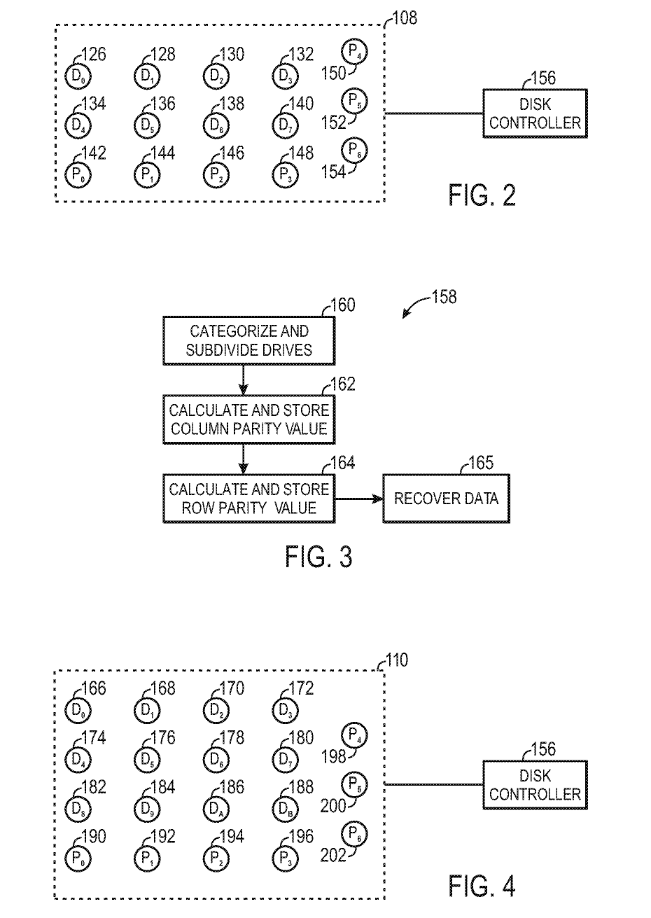

FIG. 2 illustrates an example of storage device 108 that has been set up as a RAID system. Storage device 108 includes twelve drives 126, 128, 130, 132, 134, 136, 138, 140, 142, 144, 146, 148, 150, 152, 154 (which may cumulatively be referred to as drives 126-154) that may each be a storage disk, magnetic memory device, optical memory devices, flash memory devices, etc. Moreover, storage device 108 may be coupled to a disk controller 156. This disk controller 156 may be a hardware element or may include executable code (i.e., software) that may be stored in or included on tangible machine-readable storage medium such as memory 120 or at a memory location local to the disk controller 156. In one embodiment, the disk controller 156 may separate the drives 126-154 into data drives (e.g., data drives 126, 128, 130, 132, 134, 136, 138, 140, which may cumulatively be referred to as 126-140) for storing data information and parity drives (e.g., parity drives 142, 144, 146, 148, 150, 152, 154 which may cumulatively be referred to as 142-154) for storing parity (i.e., redundancy) information. When the disk controller 156 receives data to be stored in storage device 108, for example, from host 102, the disk controller 156 may operate to stripe (i.e., segment the received data sequentially such that the received data is stored in sequential data drives, such as, data drives 126, 128, and 130). That is, the disk controller 156 may partition the received data across more than one of the data drives 126-140. This partitioning may include, for example, storing the data in analogous sector locations or utilizing analogous pointers to sector locations in sequential data drives 126-140. Additionally, upon updating any of the data drives 126-140 with data, the disk controller 156 may cause particular ones of the parity drives 142-154 to be updated with new parity information.

The disk controller may utilize a particular pattern to determine which of the parity drives 142-154 are to be updated with parity information that corresponds to the data written to respective data drives 126-140. Based on the pattern utilized to update the parity drives, storage device 108 may suffer loss of information in one or more of the drives 126-154 and will still be able to recover the originally stored information. For example, a pattern may be utilized that is a non-Maximum Distance Separable (non-MDS) erasure code such as an Exclusive Or (XOR) code. The elements of an XOR code may be defined by equations that are a logical operation of exclusive disjunction of a given set of elements. An XOR erasure code may be beneficial to use because the XOR operation is relatively simple to compute. Accordingly, XOR codes may be low-weight codes in that they have a light computation cost.

An erasure code of Hamming distance, d, tolerates all failures of fewer than d elements (either data or parity elements). The disk controller 156 may utilize a parity pattern corresponding to an erasure code that allows for total recovery of any data loss in as many as any three of the drives 126-154 (i.e., a three-disk fault tolerant code). Moreover this parity pattern may utilize recovery equations that are as small as size two (i.e., lost data may be recovered through accessing two of the drives 126-154). FIG. 3 includes a flow chart 158 that illustrates steps that may be utilized in applying an XOR erasure code for a 2-recovery equation three-disk fault tolerant code.

In step 160 of FIG. 3, the disk controller 156 may categorize the drives 126-154. In one embodiment, this categorization in step 160 includes the logical arrangement of data drives 126-140 and parity drives 142-154 illustrated in FIG. 2. That is, data drives 126-140 may be aligned into two rows and four columns, with each of parity drives 142, 144, 146,148 (which may cumulatively be referred to as 142-148) corresponding to one of the four columns and each of parity drives 150, 152,154 (which may cumulatively be referred to as 150-154) corresponding to the two rows. The subdivision of the drives in step 160 may include grouping the data drives 126-140 into two or more groups. For example, the data drives 126-140 may be divided into two groups (e.g., red and blue), such that no two data drives 126-140 of a group reside in a given column. That is, data drives 126, 128, 130, 132 (which may cumulatively be referred to as 126-132) may be subdivided into the red group while data drives 134, 136, 138, 140 (which may cumulatively be referred to as 134-140) may be subdivided into the blue group. In an alternative embodiment, the data drives 126-140 may be divided into three groups (e.g., red, blue, and green), such that no two data drives 126-140 of a group reside in a given column. That is, data drives 126, 132, and 136 may be subdivided into the red group, data drives 130, 134, and 140 may be subdivided into the blue group, while data drives 128 and 138 may be subdivided into the green group.

In step 162 of FIG. 3, the disk controller 156 may calculate and store the column parity values. That is, the disk controller 156 may calculate parity values for storage in each of parity drives 142-148 using an XOR operation on data values in analogous sector locations of specified ones of the data drives 126-140. For example, the XOR operation may include data values stored in analogous sector locations of the two data drives (e.g., data drives 126 and 134) in the column corresponding to a given parity drive (e.g., parity drive 142). The disk controller 156 may also cause the result of this XOR operation to be stored in a location in the given parity drive (e.g., parity drive 142) that corresponds to the analogous sector locations of the two data drives (e.g., data drives 126 and 134) in the column. This process of calculating and storing column parity values in step 162 may be repeated for multiple sectors of a given parity drive (e.g., parity drive 142) as well as for each of the parity drives 142-148 logically located in columns with the data drives 126-140. Accordingly, each of the parity drives 142-148 may include XOR parity information that corresponds to information stored in the drives present in the column to which it is logically paired. Thus, the parity information in parity drive 142 may correspond to the XOR of the information stored in data drives 126 and 134 (i.e., p₀=d₀⊕d₄).

In step 164, the disk controller 156 may calculate and store row parity values for parity drives 150-154. That is, the disk controller 156 may calculate parity values for storage in each of parity drives 150-154 using an XOR operation on data values in analogous sector locations of specified ones of the data drives 126-140. Moreover, particular ones of the data drives 126-140 may be chosen based on their respective subdivisions. For example, if data drives 126-140 were divided into two groups in step 160, then the parity information to be stored in parity drive 150 may correspond to the XOR of data of the red group data drives 126-132 (i.e., p₄=d₀⊕d₁⊕d₂⊕d₃), the parity information to be stored in parity drive 154 may correspond to the XOR of data of the blue group data drives 134-140 (i.e., p₆=d₄⊕d₅⊕d₆⊕d₇), and the parity information to be stored in parity drive 152 may correspond to the XOR of data of the red group data drives 126-132 and the blue group data drives 134-140 (i.e., p₅=d₀⊕d₁⊕d₂⊕d₃⊕d₄⊕d₅⊕d₆⊕d₇).

If, however, in step 160 the data drives 126-140 were subdivided into three groups, red, blue, and green, then the parity information to be stored in parity drive 150 may correspond to the XOR of data of the red group data drives 126, 132, and 136 and the data of the blue group data drives 130, 134, and 140 (i.e., p₄=d₀⊕d₃⊕d₅⊕d₂⊕d₄⊕d₇), the parity information to be stored in parity drive 152 may correspond to the XOR of data of the red group data drives 126, 132, and 136 and the data of the green group data drives data drives 128 and 138 (i.e., p₅=d₀⊕d₃⊕d₅⊕d₁⊕d₆), and the parity information to be stored in parity drive 154 may correspond to the XOR of data of the blue group data drives 130, 134, and 140 and the green group data drives data drives 128 and 138 (i.e., p₆=d₂⊕d₄⊕d₇⊕d₁⊕d₆).

In step 164, the disk controller 156 may also cause the result of these XOR operations to be stored in a location in the given parity drive (e.g., 150) that corresponds to the analogous sector locations of the data drives (e.g., red group data drives 126-132 or the red/blue group data drives 126, 130, 132, 134, 136, and 140) based on the subdivisions selected in step 160. Moreover, it should be noted that steps 162 and 164 may be repeated any time new data is written to one or more of the data drives 126-140. For example, when the data drives 126-140 are divided into two groups, and data is newly written into, for example, data drive 130, parity drives 146, 150, and 152 may be updated as described above with respect to steps 162 and 164. Additionally, for example, when the data drives 126-140 are divided into three groups, and data is newly written into, for example, data drive 130, parity drives 146, 150, and 154 may be updated as described above with respect to steps 162 and 164.

Following the procedure outlined in blocks 160, 162, and 164 of the flow chart 158 of FIG. 3, step 165 illustrates a process that will allow for any three of the drives 126-154 to fail and for information previously stored in the failed drive(s) to be recovered successfully. Moreover, recovery equations that are as small as size two (i.e., lost data may be recovered through accessing two of the drives 126-154), may be utilized to recover lost data from failed drives 126-154. For example, if a data sector, or the entire drive, fails in data drive 126, the disk controller 156 may utilize the parity information stored in parity drive 142, as well as data stored in data drive 134 to recover the data lost in data drive 126. That is, by knowing that the parity information in parity drive 142 is an XOR of the data information in data drives 126 and 134 (i.e., p₀=d₀⊕d₄), and by knowing the data stored in data drive 134 (i.e., d₄), the disk controller 156 may be able to solve for the lost information in data drive 126 (i.e., d₀). The recovery process of step 165 may be applied for combinations of three or more drives 126-154 with successful recovery.

Further, the procedure outlined in blocks 160, 162, 164, and 165 of the flow chart 158 of FIG. 3 may also be applied for encoded storage across a plurality of storage devices 108-112 in the storage system 110. That is, each of the storage devices 108-112 itself may be categorized and subsequently subdivided by the disk controller 156, or, for example, drives located in the storage devices 108-112 may, as a whole or in part, be categorized and subsequently subdivided by the disk controller 156. Additionally, the procedure outlined in flow chart 158 of FIG. 3 may also be applied to other XOR erasure codes, which may exist for systems that allow for a 3-recovery equation three-disk fault tolerant code.

FIG. 4 illustrates a second example of storage device 110 that has been set up as a RAID system. Storage device 110 includes nineteen drives 166, 168, 170, 172, 174, 176, 178, 180, 182, 184, 186, 188, 190, 192, 194, 196, 198, 200, 202 (which may cumulatively be referred to as 166-202) that may each be a storage disk, magnetic memory device, optical memory devices, flash memory devices, etc. Moreover, storage device 110 may be coupled to a disk controller 156. This disk controller 156 may be a hardware element or may include executable code (i.e., software) that may be stored in or included on tangible machine readable storage such as memory 120 or at a memory location local to the disk controller 156. In one embodiment, the disk controller 156 may separate the drives 166-202 into data drives (e.g., data drives 166, 168, 170, 172, 174, 176, 178, 180, 182, 184, 186, and 188, which may cumulatively be referred to as 166-188) for storing data information and parity drives (e.g., parity drives 190, 192, 194, 196, 198, 200, and 202, which may cumulatively be referred to as 190-202) for storing parity (i.e., redundancy) information. When the disk controller 156 receives data to be stored in storage device 110, for example, from host 102, the disk controller 156 may operate to stripe (i.e., segment the received data sequentially such that the received data is stored in sequential data drives, such as, data drives 166, 168, and 170). That is, the disk controller 156 may partition the received data across more than one of the data drives 166-188. This partitioning may include, for example, storing the data in analogous sector locations or utilizing analogous pointers to sector locations in sequential data drives 166-188. Additionally, upon updating any of the data drives 166-188 with data, the disk controller 156 may cause particular ones of the parity drives 190-202 to be updated with new parity information.

The disk controller may utilize a particular pattern to determine which of the parity drives 190-202 are to be updated with parity information that corresponds to the data written to respective data drives 166-188. Based on the pattern utilized to update the parity drives, the storage device 110 may suffer loss of information in one or more of the drives 166-202 and will still be able to recover the originally stored information. For example, a pattern may be utilized that is an XOR code.

The disk controller 156 may utilize a parity pattern corresponding to an erasure code that allows for total recovery of any data loss in as many as any three of the drives 166-202 (i.e., a three-disk fault tolerant code). Moreover this parity pattern may utilize recovery equations that are as small as size three (i.e., lost data may be recovered through accessing three of the drives 166-202). The flow chart 158 of FIG. 3 illustrates steps that may be utilized in applying an XOR erasure code for a 3-recovery equation three-disk fault tolerant code.

In step 160 of FIG. 3, the disk controller 156 may categorize the drives 166-202. In one embodiment, this categorization in step 160 includes the logical arrangement of data drives 166-188 and parity drives 190-202 illustrated in FIG. 4. That is, data drives 166-188 may be aligned into three rows and four columns, with each of the parity drives 190, 192, 194, and 196 (which may cumulatively be referred to as 190-196) corresponding to one of the four columns and parity drives 198, 200, and 202 (which may cumulatively be referred to as 198-202) corresponding to the four rows. The subdivision of the drives in step 160 may include grouping the data drives 166-188 into three groups. For example, the data drives 166-188 may be divided into three groups, red, blue, and green, such that no two data drives 166-188 of a group reside in a given column. That is, data drives 166, 168, 170, and 172 (which may cumulatively be referred to as 166-172) may be subdivided into the red group, data drives 174, 176, 178, and 180 (which may cumulatively be referred to as 174-180) may be subdivided into the blue group, while data drives 182, 184, 186, and 188 (which may cumulatively be referred to as 182-188) may be subdivided into the green group.

In step 162 of FIG. 3, the disk controller 156 may calculate and store the column parity values. That is, the disk controller 156 may calculate parity values for storage in each of parity drives 190-202 using an XOR operation on data values in analogous sector locations of specified ones of the data drives 166-188. For example, the XOR operation may include data values stored in analogous sector locations of the three data drives (e.g., data drives 166, 174, and 182) in the column corresponding to a given parity drive (e.g., parity drive 190). The disk controller 156 may also cause the result of this XOR operation to be stored in a location in the given parity drive (e.g., parity drive 190) that corresponds to the analogous sector locations of the three data drives (e.g., data drives 166, 174, and 182) in the column. This process of calculating and storing column parity values in step 162 may be repeated for multiple sectors of a given parity drive (e.g., parity drive 190) as well as for each of the parity drives 190-196 logically located in columns with the data drives 166-188. Accordingly, each of the parity drives 190-196 may include XOR parity information that corresponds to information stored in the drives present in the column to which it is logically paired. Thus, the parity information in parity drive 190 may correspond to the XOR of the information stored in data drives 166, 174, and 182 (i.e., p₀=d₀⊕d₄⊕d₈).

In step 164, the disk controller 156 may calculate and store row parity values for parity drives 198-202. That is, the disk controller 156 may calculate parity values for storage in each of parity drives 198-202 using an XOR operation on data values in analogous sector locations of specified ones of the data drives 166-188. Moreover, particular ones of the data drives 166-188 may be chosen based on their respective subdivisions (i.e., groups). For example, as the data drives 166-188 in step 160 were subdivided into three groups, (e.g., red, blue, and green,) then the parity information to be stored in parity drive 198 may correspond to the XOR of data of the red group data drives 166-172 and the data of the blue group data drives 174-180 (i.e., p₄=d₀⊕d₁⊕d₂⊕d₃⊕d₄⊕d₅⊕d₆⊕d₇), the parity information to be stored in parity drive 200 may correspond to the XOR of data of the red group data drives 166-172 and the data of the green group data drives data drives 182-188 (i.e., p₅=d₀⊕d₁⊕d₂⊕d₃⊕d₈⊕d₉⊕d_{A}⊕d_{B}), and the parity information to be stored in parity drive 202 may correspond to the XOR of data of the blue group data drives 174-180 and the green group data drives data drives 182-188 (i.e., P₆=d₄⊕d₅⊕d₆⊕d₇⊕d₈⊕d₉⊕d_{A}⊕d_{B}).

In step 164, the disk controller 156 may also cause the result of these XOR operations to be stored in a location in the given parity drive (e.g., 198) that corresponds to the analogous sector locations of the data drives (e.g., the red/blue group data drives 166-180) based on the subdivisions selected in step 160. Moreover, it should be noted that steps 162 and 164 may be repeated any time new data is written to one or more of the data drives 166-188. For example, when data is newly written into, for example, data drive 170, parity drives 194, 198, and 200 may be updated as described above with respect to steps 162 and 164. Similarly, when data is newly written into, for example, data drive 178, parity drives 194, 198, and 202 may be updated as described above with respect to steps 162 and 164.

Additionally, following the procedure outlined in blocks 160, 162, and 164 of the flow chart 158 of FIG. 3, step 165 illustrates a process that will allow for any three of the drives 166-202 to fail and for information previously stored in the failed drive(s) to be recovered successfully. Moreover, recovery equations that are as small as size three (i.e., lost data may be recovered through accessing three of the drives 166-202), may be utilized to recover lost data from failed drives 166-202. For example, if a data sector, or the entire drive, fails in data drive 166, the disk controller 156 may utilize the parity information stored in parity drive 190, as well as data stored in data drives 174 and 182 to recover the data lost in data drive 166. That is, by knowing that the parity information in parity drive 190 is an XOR of the data information in data drives 166, 174, and 182 (i.e., p₀=d₀⊕d₄⊕d₈), and by knowing the data stored in data drive 174 (i.e., d₄) and data drive 182 (i.e., d₈), the disk controller 156 may be able to solve for the lost information in data drive 166 (i.e., d₀). The recovery process of step 165 may be applied for any combination of three up drives 166-202 with successful recovery.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

What is claimed is:

1. A data storage system, comprising:
a storage device comprising:
a plurality of data storage drives logically divided into a plurality of groups arranged in a plurality of rows and a plurality of columns such that each column contains only data storage drives from distinct groups; and
a plurality of parity storage drives that correspond to the data storage drives.

2. The data storage system of claim 1, wherein at least one of the plurality of parity storage drives comprises parity data derived from an exclusive or (XOR) operation on data stored in all data storage drives in one of the plurality of columns.

3. The data storage system of claim 1, wherein at least one of the plurality of parity storage drives comprises parity data derived from an exclusive or (XOR) operation on data stored in data storage drives from at least two of the plurality of rows.

4. The data storage system of claim 1, wherein the plurality of rows comprises two rows.

5. The data storage system of claim 4, wherein the plurality of groups comprises two groups.

6. The data storage system of claim 4, wherein the plurality of groups comprises three groups.

7. The data storage system of claim 1, wherein the plurality of rows comprises three rows.

8. The data storage system of claim 7, wherein the plurality of groups comprises three groups.

9. The data storage system of claim 1, comprising a disk controller configured to logically divide the plurality of data storage drives into the plurality of groups.

10. A tangible computer-accessible storage medium, comprising code configured to cause a controller to:
categorize a storage element into data storage drives and parity storage drives;
divide the data storage drives into groups; and
logically arrange the data storage drives into a plurality of rows and a plurality of columns, such that each column contains only data storage drives from distinct groups.

11. The tangible computer-accessible storage medium of claim 10, comprising code configured to cause a controller to logically associate at least one of the parity storage drives with each of the data storage drives in one of the plurality of columns.

12. The tangible computer-accessible storage medium of claim 11, comprising code configured to cause a controller to generate and store a resultant parity value in the at least one of the parity storage drives, wherein the resultant parity value comprises data derived from data values stored in each of the data storage drives in the one of the plurality of columns.

13. The tangible computer-accessible storage medium of claim 10, comprising code configured to cause a controller to logically associate at least one of the parity storage drives with data storage drives from at least two of the plurality of rows and at least two of the distinct groups.

14. The tangible computer-accessible storage medium of claim 13, comprising code configured to cause a controller to generate and store a resultant parity value in the at least one of the parity storage drives, wherein the resultant parity value comprises data derived from data values stored in the data storage drives from the at least two of the plurality of rows and at least two of the distinct groups.

15. The tangible computer-accessible storage medium of claim 10, comprising code configured to cause a controller to recover compromised data of the storage element from data stored in at least one of the parity storage drives either alone or in conjunction with a second of the parity storage drives and/or at least one of the data storage drives.

16. A method, comprising:
receiving data for storage in a storage system;
categorizing the storage system into data storage drives and parity storage drives;
dividing the data storage drives into groups; and
logically arranging the data storage drives into a plurality of rows and a plurality of columns, such that each column contains only data storage drives from distinct groups.

17. The method of claim 16, comprising logically associating a first parity storage drive with data storage drives in one of the plurality of columns and logically associating a second parity storage drive with data storage drives from at least two of the plurality of rows and at least two of the distinct groups.

18. The method of claim 17, comprising generating and storing a resultant parity value in the first parity storage drive with resultant parity data derived from data values stored in all the data storage drives in the one of the plurality of columns.

19. The method of claim 18, comprising generating and storing a resultant parity value in the second parity storage drive with resultant parity data derived from data values stored in the data storage drives from the at least two of the plurality of rows and at least two of the distinct groups.

20. The method of claim 19, comprising recovering compromised data of the storage system from data stored in the first parity storage drive either alone or in conjunction with the second parity storage drive and/or at least one of the data storage drives.
